(19) United States
(12) Patent Application Publication
(10) Pub. No.: US 2002/0196409 A1
(43) Pub. Date: Dec. 26, 2002

(54) Lens with colored portion

(75) Inventor: Dharmendra Jani, Fairport, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 10/166,584

(22) Filed: Jun. 7, 2002

Related U.S. Application Data
(60) Provisional application No. 60/300,192, filed on Jun. 22, 2001.

(51) Int. Cl. G02C 7/04; G02C 7/02

(52) U.S. Cl. 351/162; 351/177

(57) ABSTRACT

A method of making a lens, such as a contact lens with a colored pattern, involves providing a digitized image of the pattern, and transferring the digitized image to a printable image that is printed on a surface of the lens.

### FIELD OF THE INVENTION

This invention relates a method of making lenses, especially contact lenses, having a colored portion.

### BACKGROUND OF THE INVENTION

Various colored contact lenses are known in the art. One class of colored lenses includes “cosmetic” lenses useful for enhancing or changing the apparent color of the wearer's iris. Generally, these lenses include a colored iris section, and the colored contact lenses may include an optical correction, for example, a correction to accommodate farsightedness or nearsightedness of the wearer of the contact lens; alternately, the contact lenses may be provided with the colored iris section solely for cosmetic purposes.

Examples of such contact lenses are disclosed in U.S. Pat. Nos. 5,120,121 and 4,582,402. The colored contact lenses of U.S. Pat. No. 4,582,402 are produced by printing a colored pattern over the iris section; this method involves offset pad printing where a colorant is transferred to the lens surface from a printing pad. The colored contact lenses of U.S. Pat. No. 5,120,121 are produced by applying a pattern comprised of lens forming mixture doped with a tint to a mold surface, subjecting the mold to polymerization conditions so as to partially or fully polymerize the pattern on the mold surface, dispensing a conventional lens forming monomer mixture which does not contain ink into the mold such that it submerges the previously polymerized pattern, and polymerizing this mixture to obtain a contact lens.

### SUMMARY OF THE INVENTION

According to various preferred embodiments, this invention relates to a method of making a lens, such as a contact lens, with a colored portion. The method comprises providing a digitized image, and transferring the digitized image to a printable image that is printed on a surface of the lens. The image is preferably printed on the lens surface using an inkjet printer, such as an inkjet printer comprises nozzles that independently dispense several differently colored inks. Preferably, the material applied to the lens surface is curable, and comprises a colorant and a monomeric material. The image may have the form of an annular ring corresponding to an iris portion of a contact lens.

According to other embodiments, this invention relates to a method of making a lens with a desired pattern thereon, comprising providing a digitized image of the pattern, and transferring the digitized image to a printable image that is printed on a surface of the lens, wherein a mixture of a monomeric material is applied to the lens surface and then cured. The pattern may be colored, in which case the mixture further comprises a colorant, or the pattern may be uncolored.

### BRIEF DESCRIPTION OF THE DRAWING

FIG. 1 is a schematic illustration of the method of this invention.

### DETAILED DESCRIPTION OF VARIOUS PREFERRED EMBODIMENTS

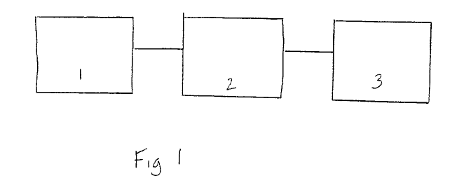

FIG. 1 illustrates the general method of this invention according to various preferred embodiments. For this described embodiment, an image of a human iris is transferred to the surface of a lens. At Step 1, an image of a human iris is captured. For example, in this step, an image of a human iris may be captured using a digital camera. The digital camera may be used to photograph a natural iris, or to photograph a previously obtained reproduction of a natural iris. At Step 2, the captured image is transferred into a desired printable image, for example, the captured image is resized or otherwise reconfigured using digitizing software to obtain the desired printable image. At Step 3, the printable image is printed on the surface of a lens, such as a contact lens, preferably by an inkjet printer. Thus, a close reproduction of the natural iris is transferred to the lens surface.

It will be appreciated that this method permits the manufacture of a custom contact lens with an iris color and pattern specifically chosen by the contact lens wearer. More specifically, the contact lens wearer may select the specific iris pattern and color that he or she desires. For example, a brown-eyed contact lens wearer may select an iris that is colored green with yellow flecks therein, from a selection of previously obtained iris patterns. Then, the manufacturer resizes the digitized image of this iris so that it is sized to match the wearer's specific iris. Subsequently, the manufacturer prints this printable image on the surfaces of contact lenses that have the optical corrections needed by the contact lens wearer.

As mentioned, an inkjet printer is preferably employed to print the printable image on the lens surface. Current inkjet technology may be employed in the method of this invention, however, it is preferred to employ inks that are compatible with the lens material and, in the case of contact lenses, may safely contact human eye tissue. There are several inkjet technologies available commercially, such as continuous mode and demand mode, including thermal inkjet and piezoelectric inkjet techniques. The preferred technique for this application is the piezoelectric, drop-on demand mode since it offers better handling and dispensing of thermally sensitive monomers and pigments, as required by this application, without degradation. Such printers typically include multiple nozzles and channels for delivering ink, for example, some current models include 300 nozzles. As known in the printing art, the number of channels and nozzles affect speed of ink delivery, ink drop size and resolution, for example. This can produce a freeform or continuous image instead of an image that is formed from discrete dots. Additionally, such printers typically deliver four differently colored inks, cyan, magenta, yellow and black, that are combined in such a manner to produce a wide variety of colors and hues using half-toning algorithms. This permits the actual rendition of the iris pattern with a very natural appearance, without having to rely on complex dot matrix or other patterns that use only two or three colors as is found in certain commercial colored lenses today.

A conventional contact lens material is hydrogel copolymers. A hydrogel is a crosslinked polymeric system that can absorb and retain water in an equilibrium state. Hydrogel copolymers are formed by polymerizing at least one hydrophilic monomer and a crosslinking agent (a crosslinker being defined as a monomer having multiple polymerizable functionalities). Representative hydrophilic monomers include: unsaturated carboxylic acids, such as methacrylic acid and acrylic acid; (meth)acrylic substituted alcohols, such as 2-hydroxyethylmethacrylate and 2-hydroxyethylacrylate; vinyl lactams, such as N-vinyl pyrrolidone; and (meth)acrylamides, such as methacrylamide and N,N-dimethylacrylamide. Typical crosslinking agents include polyvinyl, typically di- or tri-vinyl monomers, such as di- or tri(meth)acrylates of diethyleneglycol, triethyleneglycol, butyleneglycol and hexane-1,6-diol; and divinylbenzene. A specific example of a hydrogel-forming monomer mixture is polymacon, composed primarily of 2-hydroxyethylmethacrylate with a small amount of diethyleneglycol dimethacrylate as a crosslinking monomer. Optionally, the monomer mixture may include a silicone-containing monomer in order to form a silicone hydrogel copolymer. Examples of silicone-containing monomers include: monomers including a single activated unsaturated radical, such as methacryloxypropyl tris(trimethylsiloxy)silane, pentamethyldisiloxanyl methylmethacrylate, tris(trimethylsiloxy) methacryloxy propylsilane, methyldi(trimethylsiloxy) methacryloxymethyl silane, 3-[tris(trimethylsiloxy)silyl] propyl vinyl carbamate, and 3-[tris(trimethylsiloxy)silyl] propyl vinyl carbonate; and multifunctional ethylenically “end-capped” siloxane-containing monomers, especially difunctional monomers having two activated unsaturated radicals. A specific example of a silicone hydrogel-forming monomer mixture is balafilcon, based on N-vinyl pyrrolidone and the aforementioned vinyl carbonate and carbamate monomers, disclosed in U.S. Pat. No. 5,260,000. Many other lens-forming monomers and specific mixtures thereof are well known in the art. For the method of this invention, the image is preferably printed on the lens surface prior to hydrating the copolymer.

The inks employed in this invention are preferably applied to the lens surface in the form of a polymerizable fluid, and then cured (or, polymerized) to bind to the lens surface. Preferred inks are mixtures comprising a colorant, such as a pigment having the form of solid particles or a dye, and a monomeric material. The terms “monomer” or “monomeric” denote materials that are polymerizable by free radical polymerization, such as compounds containing ethylenic unsaturation. Accordingly, the monomeric material of the ink mixtures may include the aforementioned hydrophilic and/or crosslinking monomers commonly employed as lens-forming monomers; the ink monomeric material may be the same as a lens-forming monomer, or different monomers may be employed in the ink mixture and the lens-forming copolymer.

Optionally, the monomeric ink mixture may further comprise a solvent, a polymerization initiator, or a binding agent. A solvent may be employed in the ink mixture in order to obtain an ink mixture with a desired viscosity, or to assist with mixing of the colorant and monomeric material. A polymerization initiator may be included to facilitate polymerization of the monomeric material. A binding agent may be employed to facilitate binding of the colorant to the monomeric material. Alternately, although it is desired that the monomeric material, when cured, fully binds to the lens surface, a binding agent may be employed to facilitate this binding between the ink monomeric material and the lens surface.

After applying the monomeric ink mixture to the lens surface, the ink monomeric mixture is cured, for example, by thermal and/or light polymerization, typically accomplished by exposing the monomeric material to heat and/or light radiation such as UV light.

The ink may be applied to either the front or the back surface of the lens. If desired, an optional overcoat may be applied after curing the monomeric ink mixture, so that the ink material is sandwiched between the lens and this overcoat. In some cases, the overcoat may be useful to reduce any roughness of the ink layer, or to reduce exposure of eye tissue to the ink layer.

The described preferred embodiment has related to an iris image transferred to a contact lens surface for changing the apparent color of the contact lens wearer's iris. However, other embodiments are within the scope of this invention.

As a first example, a novelty design image (such as the wearer's initials, a replica of a tattoo, a shamrock, etc.) may be transferred to the contact lens surface.

As a second example, the ink monomeric mixture may include a photochromic dye that darkens or lightens in response to ambient light levels. Thus, according to this embodiment, the image would be printed at the center of the contact lens surface, so as to cover the wearer's pupil when worn. The image may further include outer annular rings, with the outer rings including a lower concentration of photochromic dye than the center of the image, so that the outer rings essentially match the pupil diameter when the pupil is expanded.

As a third example, the material printed on the lens surface may include the monomeric material but no colorant. For example, it may be desired to print a hydrophilic monomeric material on a contact lens surface, the hydrophilic monomeric material forming a layer that increases hydrophilicity and comfort of the lens surface.

As a fourth example, the material printed on the lens surface may include the monomeric material and a drug, but no colorant. For this embodiment, the drug is partially entrapped in the monomeric material and during wear of the contact lens, the drug is released slowly to eye tissue exposed to the lens surface.

Many other modifications and variations of the present invention will be evident to the skilled practitioner in the field in view of the teachings herein. It is therefore understood that, within the scope of the claims, the present invention can be practiced other than as specifically described.

I claim:

1. A method of making a lens with a colored portion, comprising providing a digitized image, and transferring the digitized image to a printable image that is printed on a surface of the lens.

2. The method of claim 1, wherein the image is printed on the lens surface using an inkjet printer.

3. The method of claim 2, wherein the inkjet printer comprises nozzles that independently dispense several differently colored inks.

4. The method of claim 3, wherein the inks are curable.

5. The method of claim 4, wherein the inks comprise a colorant and a monomeric material.

6. The method of claim 5, wherein the inks further comprise a solvent and a polymerization initiator.

7. The method of claim 6, further comprising curing the inks applied to the lens surface.

8. The method of claim 3, further comprising curing the inks applied to the lens surface.

9. The method of claim 8, wherein the inks are cured by application of light energy, heat, or both.

10. The method of claim 1, wherein the image printed on the lens surface comprises an annular ring corresponding to an iris portion of a contact lens.

11. The method of claim 1, wherein the lens is a contact lens.

12. The method of claim 11, wherein the lens is a hydrogel contact lens made from a lens-forming monomer mixture that includes a hydrophilic monomer.

13. A method of making a lens with a desired pattern thereon, comprising providing a digitized image of the pattern, and transferring the digitized image to a printable image that is printed on a surface of the lens, wherein a mixture of a monomeric material is applied to the lens surface and then cured.

14. The method of claim 13, wherein the mixture further comprises a colorant.

15. The method of claim 13, wherein the mixture is applied to the lens surface with an inkjet printer.
